(19) United States
(12) Patent Application Publication
(10) Pub. No.: US 2016/0252116 A1
(43) Pub. Date: Sep. 1, 2016

(54) Clip For A Beverage Dispensing Device

(71) Applicant: Derek Helmer, Leominister, MA (US)

(72) Inventor: Derek Helmer, Leominister, MA (US)

(21) Appl. No.: 15/054,277

(22) Filed: Feb. 26, 2016

Related U.S. Application Data
(60) Provisional application No. 62/121,560, filed on Feb. 27, 2015.

(51) Int. Cl. F16B 2/22; F16B 2/24; F16B 11/00

(52) U.S. Cl. CPC F16B 2/22; F16B 11/006; F16B 2/24

(57) ABSTRACT

A clip for a beverage dispensing device is presented. The clip includes a body and an attachment portion in mechanical communication with the body, the attachment portion for removably attaching the clip to the beverage dispensing device. The attachment portion attaches the clip in a location in close proximity to a sensor controlling a brew cycle of the beverage dispensing device.

### CROSS REFERENCE TO RELATED APPLICATIONS

The present application claims the benefit of U.S. Provisional Patent Application No. 62/121,560 filed on Feb. 27, 2015, which is incorporated herein by reference in its entirety.

### BACKGROUND

Single serve coffee is experiencing a growth explosion. Its convenience has been driven by self-contained brewers, also referred to herein as beverage dispensing device, that require only that you add water and single serve pods to brew consistently high quality cups of coffee or other beverages. The pods developed for these brewers had come from a variety of manufacturers chosen for a number of reasons including cost, design and location of manufacturing. Each of the different pod designs functioned with their own strengths and weaknesses in the brewers.

### SUMMARY

With the release of the Keurig 2.0® brewer from Green Mountain Coffee Roasters, proprietary technology was included to restrict the use of only Green Mountain manufactured pods within the beverage dispensing device. The presently described clip for a beverage dispensing device provides a solution that users could implement to defeat these restrictions and allow for the use of different pods within the beverage dispensing device.

In a particular embodiment, the invention comprises a clip that can be attached to the brewer to block the restrictive technology and allow all pods from all manufacturers that physically fit the brewer to be used.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. The drawings are not necessarily to scale, emphasis instead being placed upon illustrating the principles of the invention.

FIG. 1 comprises an isometric view of the clip for a beverage dispensing device in accordance with a particular embodiment of the present invention.

FIG. 2 comprises a top view of the clip for a beverage dispensing device in accordance with a particular embodiment of the present invention.

FIG. 3 comprises a side view of the clip for a beverage dispensing device in accordance with a particular embodiment of the present invention.

FIG. 4 comprises a front view of the clip for a beverage dispensing device in accordance with a particular embodiment of the present invention.

FIG. 5 comprises a bottom view of the clip for a beverage dispensing device in accordance with a particular embodiment of the present invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements

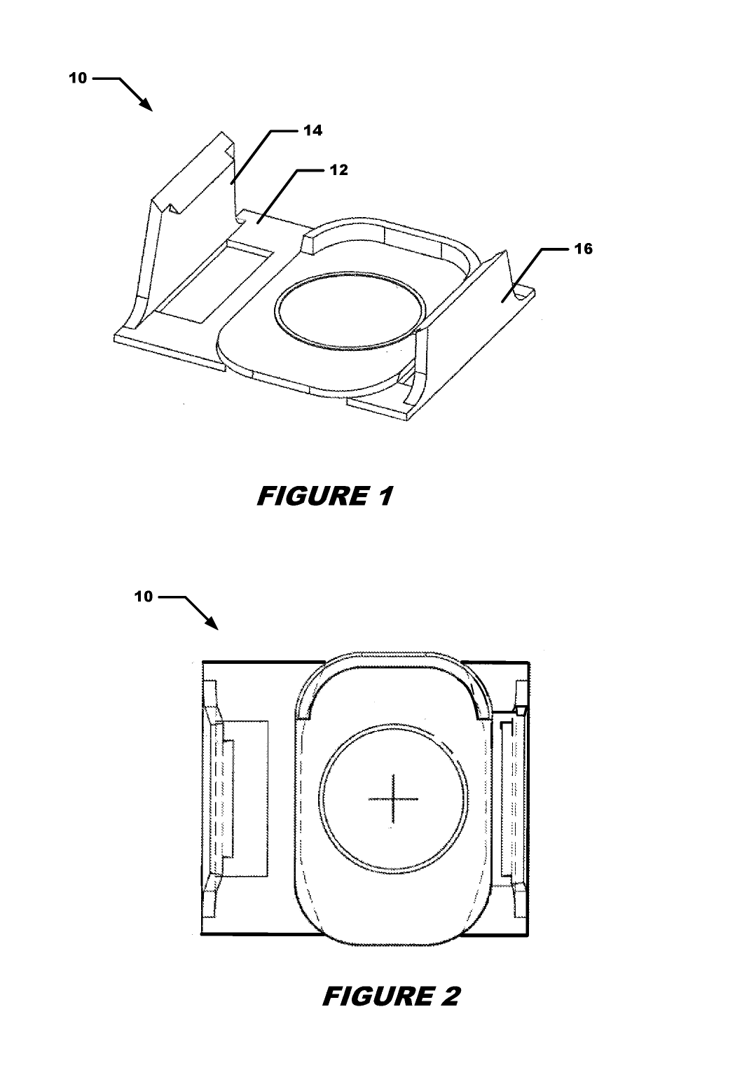

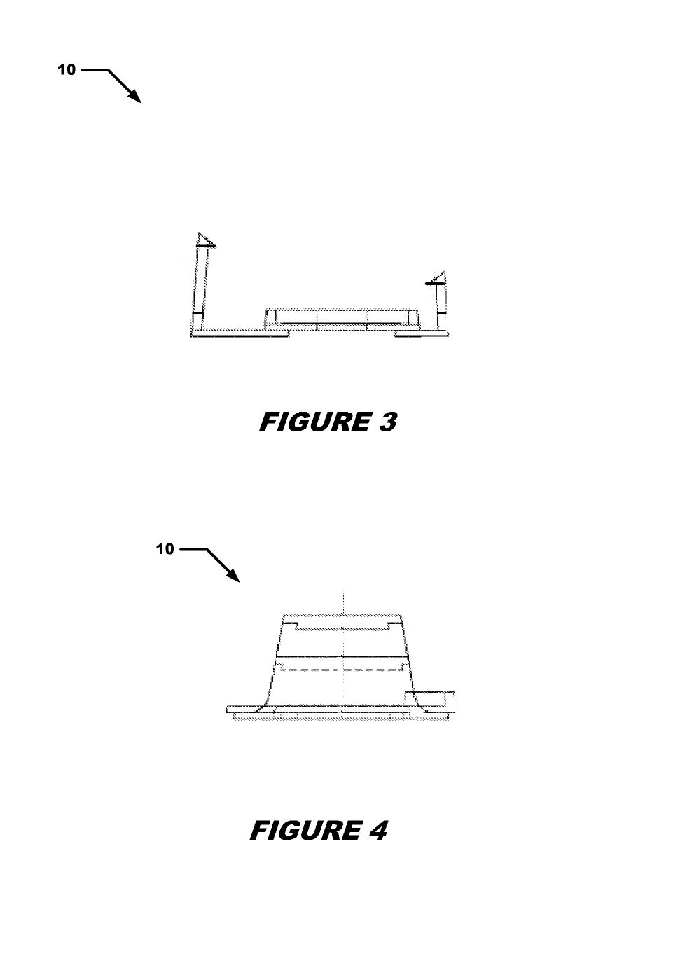

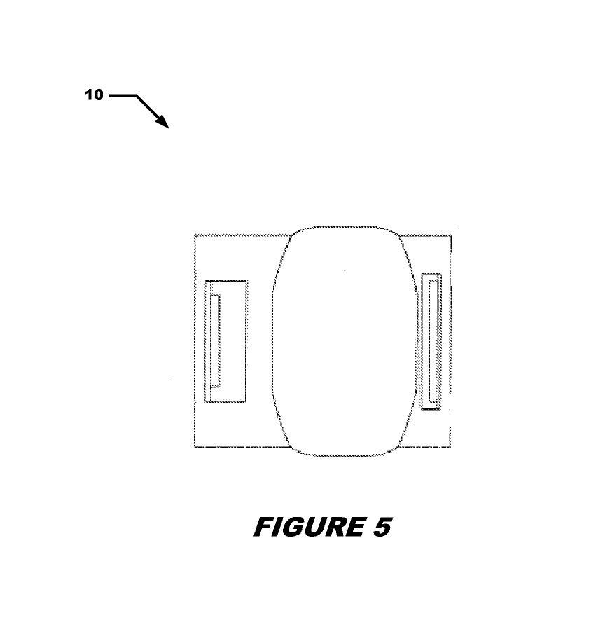

Referring now to FIGS. 1-5, a clip 10 that can be attached to the brewer to block the restrictive technology and allow all pods from all manufacturers that physically fit the brewer to be used is shown. The clip 10 includes a body 12 having a an attachment portion 14 and 16 in mechanical communication with the body 12, the attachment portion 14 and 16 for removably attaching the clip 10 to a beverage dispensing device, the attachment portion 14 and 16 attaching the clip 10 in a location in close proximity to a sensor controlling a brew cycle of the beverage dispensing device. In a particular embodiment the attachment portion includes a snap fit comprising a first flange 14 disposed on a first side of the body and a second flange 16 disposed on a second side of the body.

In alternate embodiments the clip may be attached with adhesive instead of or as well as a snap fit. The clip may also be attached with a physical device such as a secondary clip or screw instead of or as well as a snap fit. The clip maybe manufactured from a single color or in multiple colors. The clip may employ an adhesive label in the sensor location or may employ a label that requires additional method of attachment in the sensor location. The clip may have a consistent surface finish across the entire part or have multiple different surface finishes on the part possibly in the sensor location. The clip may be manufactured using a plastic material or using a metallic material.

The clip may be manufactured using a bio-compostable, bio-based or bio-degradable material. As defined herein, a product is biodegradable as long as it will completely break down and return to nature (i.e., decompose into elements found in nature) within a reasonably short period of time after customary disposal. In other words, the item will continue to disintegrate into small pieces until micro-organisms consume it. For an item to be marked compostable there must be scientific evidence that the materials in the item break down, or become part of, usable compost in a safe and timely manner in an appropriate composting facility or home compost pile.

The main difference between biodegradable and compostable is the latter breaks down into “humus,” which provides valuable nutrients to the soil. Biodegradable products just return to nature, disintegrating or disappearing completely. This disintegration could take a week or years—another difference with compostable, where items must break down in a “timely” fashion i.e., one-to-four months. Finally, compostable items must completely break down and not release any metals or toxins into the compost. Biodegradable products can leave metal residue in their return to nature.

Biodegradable refers to the breakdown of the carbon content of the material in a “reasonable timeframe”. This timeframe is loosely defined. There are four specific criteria for a material to be labeled compostable. First, it must biodegrade—at least 90% carbon content must go away within 90-180 days. Second, it must disintegrate—at least 90% of the material must disintegrate within 84 days. Third, it must not contain heavy metals above concentrations defined by North America or EU restrictions. Fourth, the disintegrated content must support future plant growth as humus. These four conditions are tested per the ASTM D6400 standard.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Accordingly, it is submitted that that the invention should not be limited to the described embodiments but rather should be limited only by the spirit and scope of the appended claims.

What is claimed is:

1. A clip comprising:
a body; and
an attachment portion in mechanical communication with said body, said attachment portion for removably attaching said clip to a beverage dispensing device, said attachment portion attaching said clip in a location in close proximity to a sensor controlling a brew cycle of said beverage dispensing device.

2. The clip of claim 1 wherein said attachment portion comprises a first flange disposed on a first side of said body.

3. The clip of claim 2 wherein said attachment portion comprises a second flange disposed on a second side of said body.

4. The clip of claim 1 wherein said attachment portion comprises an adhesive disposed on a surface of said body.

5. The clip of claim 1 wherein said attachment portion comprises a screw disposed within said body.

6. The clip of claim 1 wherein said clip is manufactured in a single color.

7. The clip of claim 1 wherein said clip is manufactured in a plurality of colors.

8. The clip of claim 1 further comprising an adhesive label disposed in the sensor location.

9. The clip of claim 1 wherein said clip further comprises a label that requires additional method of attachment in the sensor location.

10. The clip of claim 1 wherein said clip has a consistent surface finish across the entire clip.

11. The clip of claim 1 wherein said clip has multiple different surface finishes on the part

12. The clip of claim 1 wherein said clip is manufactured using a plastic material.

13. The clip of claim 1 wherein said clip is manufactured using a metallic material.

14. The clip of claim 1 wherein said clip is manufactured using a bio-compostable, bio-based or bio-degradable material.
